(19) United States
(12) Patent Application Publication
(10) Pub. No.: US 2018/0241190 A1
(43) Pub. Date: Aug. 23, 2018

(54) FIRE-RESISTANT CABLE CONNECTION

(71) Applicant: NEXANS

(72) Inventors: Franck GYPPAZ, LYON (FR); Thierry AUVRAY, LYON (FR)

(21) Appl. No.: 15/516,524

(22) PCT Filed: Sep. 22, 2015
(86) PCT No.: PCT/FR2015/052539

§ 371 Date: Apr. 3, 2017

(30) Foreign Application Priority Data
Oct. 3, 2014 (FR) 14 59477

(51) Int. Cl. H02G 15/00; H02G 15/18; H02G 3/04

(52) U.S. Cl. CPC H02G 15/003; H02G 3/0412; H02G 15/18

(57) ABSTRACT

The arrangement includes a fire-resistant cable connection, a cable connection method using such a fire-resistant connection, and a line of fire-resistant cables comprising such a fire-resistant connection.

The present invention relates to a fire-resistant cable connector, the use thereof, a process for connecting cables using such a fire-resistant connector, and a fire-resistant cable line comprising such a fire-resistant connector.

It applies typically, but not exclusively, to fire-resistant, in particular halogen-free, safety cables capable of functioning for a given period of time under fire conditions, without however spreading the fire or generating significant smoke. These safety cables are in particular medium voltage power transport cables (in particular from 6 to 45-60 kV) or low frequency transmission cables, such as control or signal cables.

In particular, the present invention applies to the connection of at least two fire-resistant safety cables. Specifically, when a portion of a fire-resistant safety cable has been damaged, in particular during a fire, or when it is very simply desired to increase the length of a fire-resistant safety cable, it is known to replace the whole of said cable with a new fire-resistant safety cable having the desired length. This solution thus makes it possible to provide a new safety cable that will prevent the spread of the flame and withstand the fire in order to function as long as possible and limit the degradation thereof under extreme thermal conditions such as a fire. However, this solution is expensive.

“Fire-resistant” junction boxes that make it possible to connect cables are available on the market such as those sold by Hensel under the references FK 7105 and FK 9105. These boxes are fastened to the cables and are either made of a halogen-free polymer material of glass-fiber-reinforced thermosetting polyester resin type or thermosetting phenolic resin type (i.e. made of thermosetting plastic material), or made of steel. However, this type of box is very bulky and is not optimized for connecting two fire-resistant cables. Specifically, the system of fastening such a box does not make it possible to ensure thermal protection of the two cables when a fire occurs, in particular in the connection zone. In particular, the box may be deformed under the effect of the heat (e.g. when the temperature is greater than 1000° C. approximately). The deformation of the box leads to the deterioration of the various polymer layers of the two cables in the connection zone and, in certain cases, the deterioration of the elongated electrically-conductive elements, in particular when they comprise aluminum (melting point of the order of 660° C.)

Generally, in order to make one or more cables fire resistant, it is known to cover said cables with an electrically-insulating layer (i.e. with a fire-resistant protective sleeve) comprising several superposed insulating strips comprising mica and glass fibers, and a polymer (e.g. polyorganosiloxane) binder in contact with each of said insulating strips. EP 2 760 030 A1 describes such a sleeve. However, its production cost is high (i.e. long and complex process for preparing the protective sleeve) and this sleeve is of large size. Moreover, this protective sleeve is difficult to install in a connection zone since it struggles to adapt to cross sections of different diameter along the cables.

Other materials such as stone, brick, cement, lead, steel, concrete, rock wool, ceramics, geopolymers, etc. have fire-resistance properties.

Cement is a pulverulent mineral material that forms, with water or with a saline solution, a binding cement slurry, capable of agglomerating, by hardening, various substances. The hardening occurs by simple hydration of calcium aluminates and calcium silicates and the binding cement slurry retains, after hardening, its strength and its stability. This binding cement slurry is also referred to as cementitious material. Cements are classified according to the EN-197-1-2000 standard into five main families: Portland cement (CEM I), Portland-composite cement (CEM II), blast furnace cement (CEM III), pozzolanic cement (CEM IV) and composite cement or slag and fly ash cement (CEM V). White cement is a Portland cement without metal oxides. Artificial cement is generally obtained by calcining mixtures of silica, alumina, calcium carbonate and optionally metal oxides such as iron oxide.

Geopolymers are considered to be alternative binders that can replace the aforementioned cementitious materials. Geopolymers are essentially mineral chemical compounds or mixtures of compounds consisting of units of silico-oxide (—Si—O—Si—O—), silico-aluminate (—Si—O—Al—O—), ferro-silico-aluminate (—Fe—O—Si—O—Al—O—) or alumino-phosphate (—Al—O—P—O—) type, created through a process of geopolymerization (i.e. polycondensation). Geopolymers may be used alone or as a mixture with organic polymers, mineral, metallic or organic fibers (e.g. glass fibers, ceramic fibers, etc.), carbon, graphite, etc. depending on the type of application desired. Among geopolymers, a distinction is made between those that are capable of polymerizing and hardening at ambient temperature, then referred to as geopolymer cements, and those that polymerize and harden under the action of heat (i.e. at a temperature above 200° C.), then referred to instead as geopolymer binders.

The most common geopolymers are those based on aluminosilicates denoted by the term “poly(sialate)” [or “poly(silico-oxo-aluminate)” or (—Si—O—Al—O—)ₙ with n denoting the degree of polymerization]. These aluminosilicate geopolymers result from the polycondensation of oligomers of oligo(sialate) type formed from a mixture of at least one aluminosilicate, of an alkali metal reactant (e.g. sodium or potassium silicate) and of water. Aluminosilicate-based geopolymers have been grouped into three families as a function of the Si/Al atomic ratio, which may be equal to 1, 2 or 3. A distinction is made between the poly(sialates) corresponding to the formula Mₙ(—Si—O—Al—O—)ₙ or (M)-PS, the poly(sialate-siloxos) corresponding to the formula Mₙ(—Si—O—Al—O—Si—O—)ₙ or (M)-PPS, and the poly(sialate-disiloxos) corresponding to the formula Mₙ(—Si—O—Al—O—Si—O—Si—O)ₙ or (M)-PSDS, with M representing at least one alkali or alkaline-earth metal cation such as K, Na or Ca and n denoting the degree of polymerization.

Geopolymer binders and cements are used in many applications: design of novel materials in the civil engineering and construction fields, creation of sculptures, manufacture of fire-retardant partitions and doors for protection against fires, and very recently as a structure of the “black box” on board aircraft.

By way of example, patent application U.S. Pat. No. 6,831,118 describes a flexible fire protection panel comprising a matrix made of plastic material (e.g. flexible elastic polyurethane) and an inorganic filler (e.g. geopolymer grains) which may be used for the fire protection of openings in walls, and also of conduits for cables.

Geopolymer compositions are also known for filling and blocking conduits for cables so as to prevent the spread of a fire from one room to another. In particular, patent application JP 2013/060543 describes a geopolymer composition comprising from 25% to 65% by weight of a solution of sodium silicate (also well known as waterglass); from 10% to 45% by weight of magnesium or aluminum hydroxide; from 10% to 45% by weight of inactive filler such as talc; and from 2% to 10% of a dispersion of rubber (e.g. styrene-butadiene) microparticles in an aqueous medium, said dispersion comprising from 30% to 60% by weight of said microparticles.

Consequently, no document from the prior art describes a composition or a material based on geopolymers that enables the connection of fire-resistant cables. Furthermore, the presence of rubber in the composition from JP 2013/060543 slows down its polymerization at ambient temperature and is not therefore suitable for enabling a rapid connection of fire-resistant cables and ensuring a good thermal protection of said cables. Finally, the flexible material from U.S. Pat. No. 6,831,118 cannot be installed easily around fire-resistant cables while maintaining a good connection with one another, and does not make it possible either to ensure a thermal protection of said cables, in particular during a fire.

The objective of the present invention is to overcome the drawbacks of the prior art techniques by providing a fire-resistant cable connector that makes it possible to effectively and rapidly connect at least two fire-resistant cables, said connector making it possible in particular to prevent the degradation of the electrically-insulating polymer layers of said cables during a fire. The connector of the present invention should also make it possible to avoid replacing a fire-resistant cable line when it is desired to lengthen it or replace a defective portion thereof.

Another objective of the invention is to provide a process for connecting fire-resistant cables that uses such a fire-resistant connector, said process being easy to carry out and making it possible to guarantee and to maintain a good connection between the cables, in particular in the event of fire.

The first subject of the present invention is a connector for at least two fire-resistant cables each comprising at least one elongated electrically-conductive element and at least one electrically-insulating sheath surrounding said elongated electrically-conductive element, the ends of said cables intended to be connected being stripped and joined end-to-end so as to ensure a physical and electrical contact between said cables, said connector being characterized in that it comprises at least one layer that comprises at least one cementitious material and that surrounds a portion of each electrically-insulating sheath and said stripped and end-to-end joined ends of said cables.

In the present invention, the term “cable connector” also means cable joint.

The layer comprising at least one cementitious material represents a protective sleeve which easily and perfectly follows the structure and the reliefs specific to the two cables, in particular at the connection zone, while limiting the size thereof.

In the present invention, the expression “cementitious material” means a solid material comprising silicon (Si), aluminum (Al), oxygen (O) and at least one element chosen from potassium (K), sodium (Na), lithium (Li), cesium (Cs) and calcium (Ca), said solid material being a geopolymer cement or being derived from a mixture consisting of a conventional anhydrous cement and water.

The cementitious material of the invention is different from a ceramic. Specifically, a ceramic differs from a cementitious material in that it is obtained using at least one sintering step (densification of a powder under the effect of heat). A cementitious material is obtained using at least one hardening or setting step, in particular by hydration or polycondensation.

In the present invention, the stripped and end-to-end joined ends of said cables consist solely of a portion of the “bare” elongated electrically-conductive elements of each of the fire-resistant cables, and are not surrounded by an electrically-insulating sheath or any other electrically-insulating or semiconducting layer. These stripped and end-to-end joined ends of said cables define a connection zone which does not therefore comprise an electrically-insulating sheath or optionally other electrically-insulating or semiconducting layers.

The layer comprising at least one cementitious material is preferably the outermost layer of the connection zone.

The electrically-insulating sheath of the fire-resistant cables is preferably halogen-free. It may be produced conventionally from materials that retard the spread of the flame or that resist the spread of the flame. In particular, if the latter do not contain halogen, they are referred to as HFFR (halogen-free flame-retardant) sheathing.

The electrically-insulating sheath of each of the fire-resistant cables represents the outermost layer of said cable (i.e. also referred to as protective outer sheath).

It comprises at least one polymer material.

The choice of the polymer material is not limiting and these materials are well known to a person skilled in the art.

According to one preferred embodiment of the invention, the polymer material is chosen from crosslinked and non-crosslinked polymers, and polymers of inorganic type and of organic type.

The polymer material may be a homopolymer or a copolymer having thermoplastic and/or elastomer properties.

The polymers of inorganic type may be polyorganosiloxanes.

The polymers of organic type may be polyurethanes or polyolefins.

The polyolefins may be chosen from polymers of ethylene and propylene. By way of example of ethylene polymers, mention may be made of linear low-density polyethylene (LLDPE), low-density polyethylene (LDPE), medium-density polyethylene (MDPE), high-density polyethylene (HDPE), ethylene/vinyl acetate copolymers (EVA), copolymers of ethylene and of butyl acrylate (EBA), of methyl acrylate (EMA), of 2-hexylethyl acrylate (2HEA), copolymers of ethylene and alpha-olefins such as for example polyethylene-octene (PEO), ethylene/propylene copolymers (EPR), or ethylene/propylene terpolymers (EPT) such as for example ethylene/propylene diene monomer (EPDM) terpolymers.

The layer comprising at least one cementitious material is preferably in direct physical contact with the portion of each electrically-insulating sheath that it surrounds (i.e. outside of the connection zone).

Each fire-resistant cable may comprise a plurality of elongated electrically-conductive elements. Thus, the electrically-insulating sheath of each fire-resistant cable surrounds the plurality of elongated electrically-conductive elements of each fire-resistant cable.

In one particular embodiment, the connector additionally comprises a metal element that makes it possible to permanently connect said stripped and end-to-end joined ends of the cables, in particular by crimping.

The metal element may be made of copper, of copper alloy, of aluminum or of aluminum alloy.

The metal element may surround a portion or the whole of the stripped and end-to-end joined ends of said cables. Thus, the metal element is located at the connection zone, between the layer comprising at least one cementitious material and the stripped and end-to-end joined ends of said fire-resistant cables. In this embodiment, the layer comprising at least one cementitious material surrounds the metal element and a portion of each electrically-insulating sheath.

The metal element is preferably in direct physical contact with at least one portion of the stripped and end-to-end joined ends of the cables.

In one preferred embodiment, the connector additionally comprises a layer consisting of a heat-shrinkable material. This layer makes it possible to protect the stripped and end-to-end joined ends of said cables and optionally the metal element from air oxidation, in particular during the connection of the cables.

The layer consisting of a heat-shrinkable material may surround a portion or the whole of the stripped and end-to-end joined ends of said cables or the metal element when it is used. Thus, the layer consisting of a heat-shrinkable material is located at the connection zone, between the layer comprising at least one cementitious material and the stripped and end-to-end joined ends of said fire-resistant cables or between the layer comprising at least one cementitious material and the metal element when it is used. In this embodiment, the layer comprising at least one cementitious material surrounds the layer consisting of a heat-shrinkable material and a portion of each electrically-insulating sheath.

According to one preferred embodiment of the invention, the heat-shrinkable material may be any heat-shrinkable substance known to a person skilled in the art.

In particular, the heat-shrinkable material may be made of polypropylene (PP), polyethylene (PE), polyethylene terephthalate (PET), polyvinyl chloride (PVC), or polystyrene (PS).

The heat-shrinkable material is preferably made of polypropylene, and more preferably made of crosslinked polypropylene.

The layer consisting of a heat-shrinkable material is preferably in direct physical contact with the layer comprising at least one cementitious material.

The connector may additionally comprise one or more silicone-type layers (i.e. comprising at least one polyorganosiloxane). Said layers may be in the form of strips or tapes.

The silicone-type layers may surround a portion of each electrically-insulating sheath and said stripped and end-to-end joined ends of said cables, or a portion of each electrically-insulating sheath and the layer consisting of a heat-shrinkable material when it exists or a portion of each electrically-insulating sheath and the metal element when it is used and when the layer consisting of a heat-shrinkable material is not present. Thus, the silicone-type layers are located between the layer comprising at least one cementitious material and the stripped and end-to-end joined ends of said fire-resistant cables or between the layer comprising at least one cementitious material and the layer consisting of a heat-shrinkable material when it exists or between the layer comprising at least one cementitious material and the metal element when it is used and when the layer consisting of a heat-shrinkable material is not present. In this embodiment, the layer comprising at least one cementitious material surrounds the silicone-type layers and optionally a portion of each electrically-insulating sheath.

The layer comprising at least one cementitious material is preferably in direct physical contact with at least one of the silicone-type layers.

The layer comprising at least one cementitious material is fire resistant. In other words, it remains intact from ambient temperature to temperatures greater than or equal to 1000° C., in particular reached during a fire, and may be subjected to extreme temperature variations without breaking.

Preferably, the connector of the invention, and in particular the layer comprising at least one cementitious material, satisfy at least any one of the following fire-resistance standards: EN50200, IEC60331-11, IEC60331-21, IEC60331-23, IEC60331-25, DIN4102, NBN713020 addendum 3, EN50577, NFC32070 CR1 and BS6387CWZ.

Advantageously, the connector of the invention, and in particular the layer comprising at least one cementitious material, satisfy the IEC60331-11 fire-resistance standard, with electrical cables under a voltage of 20 kV at 775° C. for 60 minutes.

The layer comprising at least one cementitious material may have a substantially constant thickness, in particular along the connection zone. It may be a continuous protective sleeve.

According to one preferred embodiment of the invention, the layer comprising at least one cementitious material has a thickness ranging from 0.5 to 5 cm approximately, and preferably ranging from 1 to 4 cm approximately.

The layer comprising at least one cementitious material may have a length (i.e. in the direction of the length of the cable) of at least L₁=L₀+40 approximately, L₀ and L₁ having units of cm, and L₀ representing the length of the ends of the stripped and end-to-end joined cables. In other words, the layer may cover the ends of the stripped and end-to-end joined cables and extend over a length of around 20 cm on each side of said ends so as to cover a portion of the electrically-insulating sheaths of each of the cables.

According to a first variant, the cementitious material is derived from a mixture consisting of a conventional anhydrous cement and water. The hardening then originates from the hydration of calcium silicates and calcium aluminates.

The anhydrous cement may be Portland cement and in particular white cement, or slag and fly ash cement.

According to a second variant, the cementitious material is a geopolymer cement.

In the present invention, the term geopolymer cement, or hardening of a geopolymer composition, indicates that the hardening takes place by internal reaction of polycondensation type or of hydrothermal type and that it is not the result of a simple drying, as is generally the case for binders based on alkali metal silicates.

Specifically, geopolymer cements result from an alkali-activated mineral polycondensation reaction, referred to as geosynthesis, as opposed to conventional hydraulic binders in which the hardening is the result of a hydration of the calcium aluminates and calcium silicates.

The geopolymer cement may be an aluminosilicate geopolymer cement that may have an Si/Al molar ratio ranging from 1 to 35.

The aluminosilicate geopolymer cement may be chosen from the poly(sialates) corresponding to the formula Mₙ(—Si—O—Al—O—)ₙ [(M)-PS], the poly(sialate-siloxos) corresponding to the formula Mₙ(—Si—O—Al—O—Si—O—)ₙ [(M)-PPS], and the poly(sialate-disiloxos) corresponding to the formula Mₙ(—Si—O—Al—O—Si—O—Si—O)ₙ [(M)-PSDS], with M representing at least one alkali metal cation such as K, Na, Li, Cs or a mixture thereof, and n denoting the degree of polymerization. In (M)-PS the Si/Al molar ratio is 1, in (M)-PPS it is 2 and in (M)-PPS it is 3.

The Si/Al molar ratio influences the mechanical properties of the geopolymer cement, in particular its properties of resistance to a mechanical stress. With a preferred Si/Al molar ratio ranging from 1.9 to 3 approximately and more preferably ranging from 1.9 to 2.5 approximately, the mechanical stress resistance properties of the layer are optimal.

The layer comprising at least one cementitious material may comprise one or more polymer additives that make it possible in particular to improve the mechanical properties of said layer.

Such polymer additives may be polypropylene optionally in the form of fibers; a styrene-butadiene copolymer (SBR); a styrene-butadiene-ethylene copolymer (EBS); all the derivatives of styrene-ethylene copolymers, in particular those sold by Kraton such as a styrene-ethylene-butylene-styrene copolymer (SEBS), a styrene-butadiene-styrene copolymer (SBS), a styrene-isoprene-styrene copolymer (SIS), a styrene-propylene-ethylene copolymer (EPS) or a styrene-ethylene-propylene-styrene copolymer (SEPS); an ethylene/vinyl acetate copolymer (EVA), a crosslinked polyorganosiloxane (e.g. crosslinked with a peroxide); polyethylene optionally in powder form; lignosulfonates; cellulose acetate; other derivatives of cellulose or a mixture thereof.

The layer comprising at least one cementitious material may comprise from 10% to 80% by weight approximately of polymer additives, preferably from 30% to 50% by weight approximately of polymer additives, and more preferably from 15% to 25% by weight approximately of polymer additives, relative to the total weight of said layer.

The polymer additives should not impair the electrical properties (e.g. fire resistance) and mechanical properties (e.g. resistance to a mechanical stress) of the layer comprising at least one cementitious material.

The layer comprising at least one cementitious material preferably does not comprise any inorganic compounds other than those constituting or forming part of the geopolymer cement.

According to one preferred embodiment of the invention, the layer comprising at least one cementitious material is constituted solely of said geopolymer cement.

In one particular embodiment, each of the fire-resistant cables additionally comprises at least one electrically-insulating layer between the electrically-insulating sheath and the elongated electrically-conductive element. Thus, the electrically-insulating sheath surrounds the electrically-insulating layer and the electrically-insulating layer surrounds the elongated electrically-conductive element. In this embodiment, the layer comprising at least one cementitious material surrounds a portion of each electrically-insulating sheath, a portion of each electrically-insulating layer and the stripped and end-to-end joined ends of said cables.

When each cable comprises a plurality of elongated electrically-conductive elements, it additionally comprises a plurality of electrically-insulating layers, each electrically-insulating layer individually surrounding each electrically-conductive element. Thus, the electrically-insulating sheath surrounds the plurality of electrically-insulating layers, and each electrically-insulating layer surrounds each elongated electrically-conductive element.

In this embodiment, the layer comprising at least one cementitious material surrounds a portion of each electrically-insulating sheath, a portion of each plurality of electrically-insulating layers, and the stripped and end-to-end joined ends of said cables.

The electrically-insulating layer may comprise at least one polymer material chosen from crosslinked and non-crosslinked polymers, and polymers of inorganic type and of organic type.

The polymer material may be a homopolymer or a copolymer having thermoplastic and/or elastomer properties.

The polymer material is preferably non-halogenated. The polymers of inorganic type may be polyorganosiloxanes.

The polymers of organic type may be polyurethanes or polyolefins.

The polyolefins may be chosen from polymers of ethylene and propylene. By way of example of ethylene polymers, mention may be made of linear low-density polyethylene (LLDPE), low-density polyethylene (LDPE), medium-density polyethylene (MDPE), high-density polyethylene (HDPE), ethylene/vinyl acetate copolymers (EVA), copolymers of ethylene and of butyl acrylate (EBA), of methyl acrylate (EMA), of 2-hexylethyl acrylate (2HEA), copolymers of ethylene and alpha-olefins such as for example polyethylene-octene (PEO), ethylene/propylene copolymers (EPR), or ethylene/propylene terpolymers (EPT) such as for example ethylene/propylene diene monomer (EPDM) terpolymers.

The electrically-insulating layer may additionally comprise flame-retardant fillers and/or inert fillers (or non-combustible filler).

The choice of the flame-retardant fillers and/or inert fillers is not limiting and these fillers are well known to a person skilled in the art.

The flame-retardant fillers may be chosen from hydrated fillers, in particular from metal hydroxides such as for example magnesium dihydroxide (MDH) or aluminum trihydroxide (ATH), and other mineral fillers such as CaO or phyllosilicates.

These flame-retardant fillers act mainly via a physical route by decomposing endothermically (e.g. release of water), the result of which is to lower the temperature of the electrically-insulating layer and to limit the spread of the flames along the cable. Reference is in particular made to the flame-retardant properties.

The inert fillers may be chalk, talc, clay (e.g. kaolin), carbon black, or carbon nanotubes.

A second subject of the present invention is a process for connecting at least two fire-resistant cables each comprising at least one elongated electrically-conductive element and at least one electrically-insulating sheath surrounding said elongated electrically-conductive element, said process being characterized in that it uses a connector as defined in the first subject of the invention and in that it comprises at least the following steps:

i) a step of baring the ends of said cables intended to be connected and of end-to-end joining said bared (i.e. stripped) ends of said cables,

ii) a step of molding a geopolymer composition or a mixture consisting of a conventional anhydrous cement and water, around said stripped and end-to-end joined ends of said cables and a portion of each electrically-insulating sheath, and

iii) a step of hardening the geopolymer composition or the mixture consisting of a conventional anhydrous cement and water (i.e. cement slurry) in order to form a layer that comprises at least one cementitious material and that surrounds a portion of each electrically-insulating sheath and said stripped and end-to-end joined ends of said cables.

The process in accordance with the invention is rapid and simple. It makes it possible to connect fire-resistant cables in order to lengthen a fire-resistant cable line, or to replace a defective portion of a cable line while maintaining its fire-resistance properties.

Step i) makes it possible to ensure the physical and electrical contact between said cables.

The conventional anhydrous cement used in step ii) is as defined in the first subject of the invention.

The geopolymer composition from step ii) may be an aluminosilicate geopolymer composition.

The geopolymer composition from step ii) then preferably corresponds to the following molar composition (I):

wSiO₂:xAl₂O₃:yM₂O:zH₂O (I)

in which:
M is chosen from Na, K, Li, Cs and a mixture thereof,
w is a value between 0.1 and 8 approximately,
x is a value between 0.1 and 0.3 approximately,
y is a value between 0.05 and 0.2 approximately,
w is a value between 0.8 and 3 approximately,

said composition comprising from 40% to 79% by weight approximately of solids (SiO₂, Al₂O₃, M₂O), relative to the total weight of said composition.

The water/solids weight ratio in said geopolymer composition determines the solidification kinetics during step iii). Thus, a low water/solids weight ratio may reduce the setting time at ambient temperature.

The process may additionally comprise, before step ii), a step ii₀) of preparing a geopolymer composition.

Step ii₀) is generally carried out at a high pH, in particular strictly greater than 13.

When the composition is an aluminosilicate geopolymer composition, step ii₀) preferably comprises the following substeps:

ii₀₋₁) a step of preparing an aqueous alkali metal silicate solution having an SiO₂/M₂O molar ratio ranging from 1.65 to 3.4 approximately, the weight concentration of the alkali metal silicate in the water possibly ranging from 35% to 90% approximately, and

ii₀₋₂) a step of mixing an aluminosilicate in powder form having an Al₂O₃/SiO₂ molar ratio ranging from 0.4 to 0.8 with the aqueous alkali metal silicate solution prepared in the preceding step, the weight concentration of the aluminosilicate in the aqueous alkali metal silicate solution prepared in the preceding step possibly ranging from 10% to 80% approximately, and preferably from 25% to 65% approximately.

The aluminosilicate may be chosen from metakaolin (i.e. calcined kaolin), fly ash, blast furnace slag, expansive clays such as bentonite, calcined clays, any type of compound comprising aluminum and silica fume, zeolites and a mixture thereof. The aluminosilicates sold by the company Imérys, such as metakaolin, will be preferred.

The aqueous alkali metal silicate solution may be prepared by mixing silicon dioxide SiO₂ or an alkali metal silicate with a base MOH.

The silicon dioxide SiO₂ may be chosen from silica fume (i.e. fumed silica), quartz, and a mixture thereof.

The alkali metal silicate may be chosen from sodium silicates, potassium silicates and a mixture thereof. The alkali metal silicates sold by the company Silmaco and the company PQ Corporation will be preferred.

The base MOH may be chosen from KOH, NaOH and a mixture thereof.

Step ii₀₋₁) may be carried out by dissolving the base in water, leading to a release of heat (exothermic reaction), then by adding the silica (or the alkali metal silicate). The heat released then accelerates the dissolving of the silica (or of the alkali metal silicate) during step ii₀₋₁) and of the aluminosilicate during step ii₀₋₂) and therefore the setting of the geopolymer composition.

At the end of step ii₀₋₂), the geopolymer composition has a viscosity that increases with time. It cannot therefore be stored and it must immediately be used in the next molding step ii).

The process may additionally comprise, after step i), a step ii) of permanently connecting the stripped and end-to-end joined ends of said cables by means of a metal element. In this embodiment, the connector additionally comprises said metal element.

The metal element is as defined in the first subject of the invention.

Step i₁) may be carried out by crimping.

The process may additionally comprise, between step i) and step ii) or between step i) and step i₁), a step i₂) of applying a layer consisting of a heat-shrinkable material around the stripped and end-to-end joined ends of said cables or around the metal element. In this embodiment, the connector additionally comprises said layer consisting of a heat-shrinkable material.

The layer consisting of a heat-shrinkable material is as defined in the first subject of the invention.

The process may additionally comprise, between step i) and step ii) or between step i₁) and step ii) or between step i₂) and step ii), a step i₃) of applying one or more silicone-type layers around the stripped and end-to-end joined ends of said cables and a portion of each electrically-insulating sheath or around the metal element and a portion of each electrically-insulating sheath or around the layer consisting of a heat-shrinkable material and a portion of each electrically-insulating sheath.

The silicone-type layers are as defined in the first subject of the invention.

The geopolymer composition (respectively the cement slurry) may comprise one or more polymer additives that make it possible in particular to improve the mechanical properties of said composition, one or more dispersants, one or more compounds that accelerate setting (i.e. hardening of the geopolymer composition, respectively of the cement slurry), or a mixture thereof.

As examples of polymer additives, mention may be made of a polypropylene optionally in the form of fibers; a styrene-butadiene copolymer (SBR); a styrene-butadiene-ethylene copolymer (EBS); all the derivatives of styrene-ethylene copolymers, in particular those sold by Kraton such as a styrene-ethylene-butylene-styrene copolymer (SEBS), a styrene-butadiene-styrene copolymer (SBS), a styrene-isoprene-styrene copolymer (SIS), a styrene-propylene-ethylene copolymer (EPS) or a styrene-ethylene-propylene-styrene copolymer (SEPS); an ethylene/vinyl acetate copolymer (EVA), a crosslinked polyorganosiloxane (e.g. crosslinked with a peroxide); polyethylene optionally in powder form; lignosulfonates; cellulose acetate; other derivatives of cellulose or a mixture thereof.

As examples of dispersants, that is to say of compounds that make it possible to improve the rheological properties of the geopolymer composition or of the cement slurry, mention may be made of a naphthalenesulfonic acid-formaldehyde condensate, an acetone-formaldehyde-sulfite condensate, a melamine sulfonate-formaldehyde condensate, or a mixture thereof.

As examples of compounds that accelerate setting (i.e. hardening of the geopolymer composition or of the cement slurry), mention may be made of aluminum sulfate, alums (e.g. potassium aluminum double sulfate), calcium chloride, calcium sulfate, hydrated calcium sulfate, sodium aluminate, sodium carbonate, sodium chloride, sodium silicate, sodium sulfate, iron (III) chloride, sodium lignosulfonates or a mixture thereof.

The layer comprising at least one cementitious material may comprise from 15% to 30% by weight approximately of setting accelerants relative to the total weight of said layer.

The geopolymer composition (respectively the cement slurry) preferably does not comprise inorganic compounds other than those that participate in the formation of the cementitious material.

According to one preferred embodiment of the invention, the geopolymer composition (respectively the cement slurry) consists only of compounds that participate in the formation of the cementitious material.

The molding step ii) is preferably carried out in a cylindrical mold, for example by pouring the geopolymer composition or the cement slurry over said stripped and end-to-end joined ends of said cables and a portion of each electrically-insulating sheath.

Step iii) is generally carried out at ambient temperature since the polymerization (in the case of the formation of the geopolymer cement) or the hydration (in the case of the formation of the cementitious material resulting from a mixture consisting of a conventional anhydrous cement and water) takes place at ambient temperature.

The speed of hardening of step iii) may range from 30 to 300 minutes approximately at 25° C. approximately (i.e. at ambient temperature).

However, it is entirely possible to accelerate the hardening of the geopolymer composition or of the cement slurry by carrying out step iii) at a temperature ranging from 70° C. to 200° C. approximately, in particular with the aid of a conventional convection oven, an infrared oven or a microwave oven.

The process of the invention may additionally comprise a step iv) of removal from the mold.

A third subject of the present invention is the use of a connector as defined in the first subject of the invention for lengthening a fire-resistant cable line or for replacing a defective portion of a fire-resistant cable line.

A fourth subject of the present invention is a fire-resistant cable line comprising at least:
a first fire-resistant cable comprising at least one elongated electrically-conductive element and at least one electrically-insulating sheath surrounding said elongated electrically-conductive element, and
a second fire-resistant cable comprising at least one elongated electrically-conductive element and at least one electrically-insulating sheath surrounding said elongated electrically-conductive element,

the ends of said cables intended to be connected being stripped and joined end-to-end so as to ensure a physical and electrical contact between said cables,

said cable line being characterized in that it additionally comprises a connector as defined in the first subject of the invention.

The following examples make it possible to illustrate the present invention. They in no way limit the overall scope of the invention as presented in the claims. The ratios between the oxides are molar ratios and the % indicated are by weight.

### EXAMPLES

The raw materials used in the examples are listed below:
approximately 50 wt % aqueous sodium silicate solution of waterglass type, from Simalco, of formula Na₂O.2SiO₂ and with an SiO₂/Na₂O molar ratio of 2 approximately,
tap water,
potassium hydroxide, from Sigma-Aldrich, with a purity >85%,
Polestar® 450 aluminosilicate, from Imerys, with an Al₂O₃/SiO₂ molar ratio of 41/55 (i.e. of 0.745 approximately).

Unless otherwise indicated, all these raw materials were used as received from the manufacturers.

### Example 1: Process for Connecting Two Fire-Resistant Cables in Accordance with the Invention

1.1. Preparation of an Aluminosilicate Geopolymer Composition (Step ii₀)

An alkali metal silicate solution is prepared by mixing 1000 g of an aqueous sodium silicate solution, 300 g of water and 180 g of potassium hydroxide. Then 600 g of aluminosilicate were mixed with the alkali metal silicate solution to form an aluminosilicate geopolymer composition.

Said aluminosilicate geopolymer composition comprised 54% by weight approximately of solids relative to the total weight of said composition.

The aluminosilicate geopolymer composition had the following molar composition of formula (I):

0.54SiO₂:0.16Al₂O₃:0.1K₂O:2.3H₂O (I)

### 1.2. Connection of Two Fire-Resistant Cables

Two identical cables were used in the present example. Each cable comprised four elongated electrically-conductive elements made of copper having a cross section of 50 mm², each of the four elongated electrically-conductive elements made of copper being insulated by an electrically-insulating layer, and an electrically-insulating sheath surrounding said insulated four elongated electrically-conductive elements made of copper. The electrically-insulating layers were based on a crosslinked polyorganosiloxane. The electrically-insulating sheath was of HFFR type based on an ethylene/vinyl acetate copolymer (EVA).

The ends of said cables intended to be connected were stripped.

Next, a tube made of heat-shrinkable material sold by Huber-Suhner Suisse under the reference Sucofit was placed around said cables and in particular around the stripped ends of said cables. The tube was able at this stage to be moved manually along the longitudinal axis of the cables, in particular in order to be able to view the stripped ends and join them end-to-end manually. The stripped ends of said cables were thus joined end-to-end manually and permanently connected using a metal element (conventional connector) by crimping.

Finally, the tube made of heat-shrinkable material was again moved along the longitudinal axis of the cables so as to position it at the stripped and end-to-end joined ends of said cables (i.e. connection zone); then it was shrunk by heating, so as to form a layer consisting of said heat-shrinkable material. The stripped and end-to-end joined ends of said cables permanently covered by the layer consisting of said heat-shrinkable material were thus obtained.

The geopolymer composition prepared in example 1.1 was molded around the layer consisting of a heat-shrinkable material with the aid of a cylindrical mold.

The assembly (cables and connector) was then dried at ambient temperature for 24 hours, then removed from the mold.

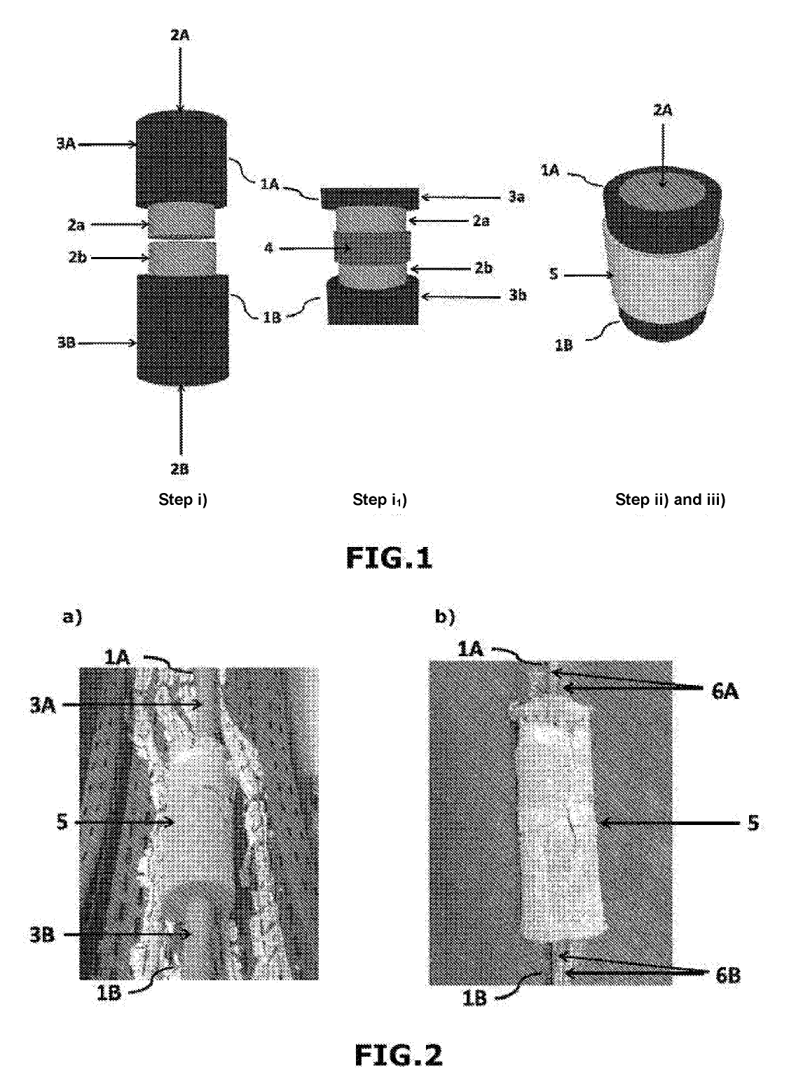

FIG. 1 is a schematic representation of the process in accordance with the present invention.

The process described in FIG. 1 relates to the connection of two fire-resistant cables (1A, 1B) each comprising an elongated electrically-conductive element (2A, 2B) and an electrically-insulating sheath (3A, 3B) surrounding said elongated electrically-conductive element (2A, 2B).

According to a first step i), the ends that are intended to be connected of said cables (1A, 1B) were stripped and joined end-to-end.

Next, according to a step ii), the stripped and end-to-end joined ends (2a, 2b) are permanently connected using a metal element (4) by crimping (connection zone).

Finally, according to a step ii), a geopolymer composition is molded around said stripped and end-to-end joined ends (2a, 2b) of said cables (1A, 1B) and a portion (3a, 3b) of each electrically-insulating sheath (3A, 3B).

After step iii) of hardening the geopolymer composition at ambient temperature, a layer (5) comprising at least one geopolymer cement is formed around the metal element (4), said stripped and end-to-end joined ends (2a, 2b) of said cables (1A, 1B) and a portion (3a, 3b) of each electrically-insulating sheath (3A, 3B).

### 1.3. Connector Performance

The cable connector comprising a layer of geopolymer cement and a metal element was evaluated with regard to the flame resistance performance. The assembly was placed in a furnace and exposed to a temperature close to 1000° C. for 2 hours.

FIG. 2 represents images of the cable connector before the exposure test at a temperature close to 1000° C. for 2 hours (FIG. 2a) and of the cable connector after the test (FIG. 2b).

As can be seen in FIG. 2, after the test, the residual mechanical cohesion of the geopolymer cement layer (5) indicates that the geopolymer cement protects the connection zone defined by the stripped and end-to-end joined ends (2a, 2b) of the cables (1A, 1B). The electrically-insulating layers (6A, 6B) respectively underneath each electrically-insulating sheath (3A, 3B) of each of the cables (1A, 1B) surrounding the elongated electrically-conductive elements (2A, 2B) are very slightly deteriorated. Consequently, the geopolymer cement layer (5) very greatly limits the heat transfers. Furthermore, it has been noted that the internal portion of the connection zone is completely intact and that no trace of degradation or of overheating is visible. The electrically-insulating sheath (3A, 3B), for its part, does not withstand such temperatures and is degraded by combustion.

1. A connector for at least two fire-resistant cables each comprising:
at least one elongated electrically-conductive element and at least one electrically-insulating sheath surrounding said elongated electrically-conductive element, the ends of said cables configured to be stripped and joined end-to-end so as to ensure a physical and electrical contact between said cables, wherein at least one layer that comprises at least one cementitious material and that surrounds a portion of each electrically-insulating sheath and said stripped and end-to-end joined ends of said cables.

2. The connector as claimed in claim 1, wherein the layer comprising at least one cementitious material is in direct physical contact with the portion of each electrically-insulating sheath that it surrounds.

3. The connector as claimed in claim 1, wherein said connector additionally comprises a metal element that makes it possible to permanently connect said stripped and end-to-end joined ends of the cables.

4. The connector as claimed in claim 3, wherein the metal element is made of copper, of copper alloy, of aluminum or of aluminum alloy.

5. The connector as claimed in claim 3, wherein the metal element is in direct physical contact with at least one portion of the stripped and end-to-end joined ends of the cables.

6. The connector as claimed in claim 1, wherein said connector additionally comprises a layer of a heat-shrinkable material.

7. The connector as claimed in claim 6, wherein the layer of a heat-shrinkable material surrounds a portion or the whole of the stripped and end-to-end joined ends of said cables or the metal element when it is used.

8. The connector as claimed in claim 6, wherein the layer of a heat-shrinkable material is in direct physical contact with the layer comprising at least one cementitious material.

9. The connector as claimed in claim 1, wherein the layer comprising at least one cementitious material has a thickness ranging from 0.5 to 5 cm.

10. The connector as claimed in claim 1, wherein the layer comprising at least one cementitious material has a length of at least L₁=L₀+40, L₀ and L₁ having units of cm, and L₀ representing the length of the ends of the stripped and end-to-end joined cables.

11. The connector as claimed in claim 1, wherein the cementitious material is a solid material comprising silicon (Si), aluminum (Al), oxygen (O) and at least one element chosen from potassium (K), sodium (Na), lithium (Li), cesium (Cs) and calcium (Ca), said solid material being a geopolymer cement or being derived from a mixture of a conventional anhydrous cement and water.

12. The connector as claimed in claim 11, wherein the anhydrous cement is Portland cement or slag and fly ash cement.

13. The connector as claimed in claim 11, wherein the geopolymer cement is an aluminosilicate geopolymer cement.

14. A process for connecting at least two fire-resistant cables each comprising at least one elongated electrically-conductive element and at least one electrically-insulating sheath surrounding said elongated electrically-conductive element, said process being characterized in that it uses a connector as defined in claim 1 and in that said process comprises at least the following steps:
i) a step of baring the ends of said cables intended to be connected and of end-to-end joining said bared ends of said cables,
ii) a step of molding a geopolymer composition or a mixture consisting of a conventional anhydrous cement and water, around said stripped and end-to-end joined ends of said cables and a portion of each electrically-insulating sheath, and
iii) a step of hardening the geopolymer composition or the mixture consisting of a conventional anhydrous cement and water, in order to form a layer that comprises at least one cementitious material and that surrounds a portion of each electrically-insulating sheath and said stripped and end-to-end joined ends of said cables.

15. A method for lengthening a fire-resistant cable line or for replacing a defective portion of a fire-resistant cable line, said method comprising the steps of:
inserting a connector as defined in claim 1, into said fire-resistant cable line.

16. A fire-resistant cable line comprising at least:
a first fire-resistant cable comprising at least one elongated electrically-conductive element and at least one electrically-insulating sheath surrounding said elongated electrically-conductive element, and
a second fire-resistant cable comprising at least one elongated electrically-conductive element and at least one electrically-insulating sheath surrounding said elongated electrically-conductive element,
the ends of said cables intended to be connected being stripped and joined end-to-end so as to ensure a physical and electrical contact between said cables,
wherein said fire-resistant cable line additionally comprises a connector as defined in claim 1.
